(19) United States
(12) Patent Application Publication
(10) Pub. No.: US 2026/0222012 A1
(43) Pub. Date: Jul. 30, 2026

(54) Methods and Apparatuses for Diversity Transmission in a Satellite-Based Communication System

(71) Applicant: ViaSat, Inc., Carlsbad, CA (US)

(72) Inventors: James E. Petranovich, La Jolla, CA (US); Kenneth V. Buer, Bluff City, TN (US); Simon Fabbri, Échichens (CH)

(21) Appl. No.: 19/146,980

(22) PCT Filed: Jan. 17, 2023
(86) PCT No.: PCT/US2023/010920

§ 371 Date: Jul. 10, 2025

(51) Int. Cl. H04B 7/02; H04B 7/06; H04B 7/185

(52) U.S. Cl. CPC H04B 7/028; H04B 7/0617; H04B 7/0626; H04B 7/18513; H04B 7/18515

(57) ABSTRACT

A satellite communication system uses a plurality of optical feeder links between its ground segment and its space segment and employs spatial diversity transmission, which splits individual user data streams into sub-streams sent across two or more of the optical feeder links such that recovery of the full stream at the receiving end is possible despite impairments affecting individual feeder links over which the stream is split. Further, the system applies beamforming separately with respect to the feeder links, meaning that transmission time alignment is not needed between respective ones of the sub-streams. Spatial diversity transmission occurs in the forward direction or in the return direction or both and may be employed on a conditional basis and dynamically adjusted with respect to individual user terminals, groups of user terminals, or whole populations of user terminals.

### TECHNICAL FIELD

A satellite communication system employs multiple free space optical links supported by respective ground stations, to provide spatially diverse transmission of user data streams in one or both the forward-link and return-link directions.

### BACKGROUND

Multiple challenges arise in the context of designing, deploying, and operating satellite communication networks, with capacity limitations and spectrum efficiency representing recurring issues with no simple solutions. Increasing data rates needed for delivery of richer media and the desire to reduce latency exacerbate such issues.

One approach taken in addressing bandwidth limitations involves the use of free space optical “feeder links” between a satellite and the terrestrial gateways stations that send forward traffic to the satellite and receive return traffic from the satellite. Certain satellite communication systems also use optical links for inter-satellite communications, with these inter-satellite links improving overall capacity or providing additional coverage and traffic routing flexibility.

Despite offering significant bandwidth gains and concomitant improvements in feeder-link capacity as compared to radio frequency (RF) feeder links, optical feeder links are prone to impairment as a consequence of cloud cover and atmospheric effects such as beam wandering and scintillation. Scintillation arises from fluctuation of the index of refraction due to small variations of temperature in the propagation medium, resulting in variation of the received optical power. Due to these impairments, an optical feeder link is more prone to severe signal degradation or complete signal loss than a RF feeder link.

Using diverse optical links ameliorates the problems arising with use of a single optical link but diversity transmissions over multiple optical links brings its own challenges in terms of how to use the multiple links for transmitting the information in question. Further challenges arise in the context of underlying technologies, such as ground-based beamforming, where the ground segment of a satellite communication system performs or controls the signal weightings used to form forward or return beams used to serve user terminals in different locations.

### SUMMARY

A satellite communication system uses a plurality of optical feeder links between its ground segment and its space segment and employs spatial diversity transmission, which splits individual user data streams into sub-streams sent across two or more of the optical feeder links such that recovery of the full stream at the receiving end is possible despite impairments affecting individual feeder links over which the stream is split. Further, the system applies beamforming separately with respect to the feeder links, meaning that transmission time alignment is not needed between respective ones of the sub-streams. Spatial diversity transmission occurs in the forward direction or in the return direction or both and may be employed on a conditional basis and dynamically adjusted with respect to individual user terminals, groups of user terminals, or whole populations of user terminals.

An example embodiment comprises a method of operation by a satellite communication system comprising a ground segment and a space segment. The method includes providing a plurality of forward user beams for conveying forward user traffic to respective user terminals. Each forward user beam has a corresponding forward user beam coverage area and at least one subset of the forward user beams is arranged as a forward spatial diversity beam subset comprising two or more forward user beams having distinctive combinations of signal frequency and polarization and having respective forward user beam coverage areas that overlap by more than a threshold amount. The method further includes, for each forward spatial diversity beam subset, transmitting the forward user traffic mapped to each forward user beam included in the forward spatial diversity beam subset from the ground segment to the space segment via a different optical forward uplink signal originating from a different one among two or more geographically distributed ground stations.

Still further, for at least one user terminal located in the overlapped forward beam coverage areas of a given forward spatial diversity beam subset, the method includes employing diversity forward transmission by: (a) dividing an incoming user data stream targeted to the user terminal into two or more forward user data sub-streams by block encoding the incoming user data stream and dividing the resulting encoded blocks such that each forward user data sub-stream carries different subsets of encoded data from the encoded blocks; and (b) mapping each forward user data sub-stream to a different one of the forward user beams included in the given forward spatial diversity subset. With this approach, each forward user data sub-stream undergoes ground-based beamforming separate from the other sub-streams, such that transmission time alignment between the respective sub-streams across the involved ground stations is not required for coherent beamforming.

A method according to a further embodiment includes receiving incoming user data streams at a processing node of the ground segment, each incoming user data stream targeting a respective user terminal served by the satellite communication system, with the method further including employing forward spatial diversity transmission for one or more of the incoming user data streams.

Employing forward spatial diversity transmission comprises, for each such incoming user data stream, forming a corresponding set of two or more forward user data sub-streams by block encoding the incoming user data stream and dividing each encoded data block into different subsets of encoded data, mapping each forward user data sub-stream to a respective one among two or more forward beam signals respectively corresponding to two or more forward user beams of the satellite communication system that have respective forward user beam coverage areas encompassing a location of the user terminal targeted by the incoming user data stream, and transmitting each forward beam signal from the ground segment to the space segment via a different optical forward uplink signal originating from a different ground station among a plurality of geographically distributed ground stations comprised in the ground segment. Each such forward uplink signal multiplexes a plurality of forward optical channel signals conveying respective copies of the forward beam signal weighted for beamforming transmission from respective antenna elements of a targeted antenna array in the space segment, for far-field formation of the corresponding forward user beam.

In the context of the foregoing method, the satellite communication system provides a plurality of forward user beams via one or more satellites comprised in the space segment, each forward user beam based on a corresponding forward user beam signal and having a respective combination of downlink signal frequency and polarization. Correspondingly, the method may further include receiving, at each of one or more ground stations among the plurality of the ground stations, two or more forward beam signals corresponding to two or more forward user beams having the same respective combination of downlink signal frequency and polarization. For each such ground station the method includes: (a) forming a respective set of forward beam element signals for each of the two or more forward beam signals by generating a set of radio frequency signals, each radio frequency signal corresponding to an antenna element of a targeted satellite antenna array and modulated by the forward beam signal, and weighting each radio frequency signal with a corresponding forward beam weight from a corresponding set of forward beam weights calculated such that simultaneous transmission of the set of forward beam element signals from the targeted satellite antenna forms the corresponding forward user beam in the far field; (b) combining the respective sets of forward beam element signals to form a set of combined forward beam element signals; (c) modulating each optical carrier among a plurality of optical carriers at different wavelengths with a respective one among the set of combined forward beam element signals, to obtain a plurality of forward optical channel signals; (d) multiplexing the plurality forward optical channel signals in the optical domain to form a corresponding optical forward uplink signal; and (e) transmitting the corresponding optical forward uplink signal toward a satellite having the targeted satellite antenna array.

The foregoing ground-station processing may occur for more than one set of forward beam signals, with each set representing a corresponding set of forward user beams. For each set of forward beam signals, the ground station forms a set of combined forward beam element signals and modulates a corresponding set of optical carriers to obtain a corresponding set of forward optical channel signals. Each set of forward optical channel signals resides in a different segment of optical spectrum, such that the multiple sets of forward optical channel signals may be “stacked” in the optical domain, to form a corresponding optical forward uplink signal having an overall bandwidth that spans the respective chunks of optical spectrum occupied by the individual sets of forward optical channel signals.

Another embodiment comprises a method of operation by a satellite communication system comprising a ground segment and a space segment, where the method includes receiving two or more return user data sub-streams via one or more satellites comprised in the space segment. The two or more return user data sub-streams are transmitted by a same user terminal that block encodes a return user data stream and divides the resulting block-encoded data into the two or more return user data streams, with each return user data sub-stream conveying a different portion of the encoded data from each encoded block. The method further includes conveying each return user data sub-stream to the ground segment via a different optical return downlink signal, each optical return downlink signal received at a different ground station among a plurality of geographically distributed ground stations comprised in the ground segment, and receiving, at a processing node of the ground segment, each of the two or more return user data sub-streams from the respective ground stations that each received one of the two more return user data sub-streams. The method further includes the processing node reassembling the return user data stream from the return user data streams, for forwarding toward a targeted destination. Such operations in one or more embodiments or variations include performing return beamforming in the ground segment, to enhance return uplink signals with respect to return user beam coverage areas that may correspond with some or all of the forward user beam coverage areas.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a satellite communication system that provides spatial transmit diversity over free space optical links between ground stations and satellites, according to one embodiment.

FIG. 2 is a block diagram of example details for a spatial diversity transmit processing arrangement, according to one embodiment.

FIGS. 3 and 4 are block diagrams of example details for a ground station, according to one embodiment.

FIG. 5 is a block diagram of example details for an optical transmitter, according to one embodiment.

FIG. 6 is a diagram of example multiplexing in the optical domain, according to one embodiment.

FIG. 7 is a block diagram of example details for an optical transmitter, according to one embodiment.

FIG. 8 is a block diagram of example details for a satellite, according to one embodiment.

FIGS. 9-11 are block diagrams of example details for a user terminal, according to one embodiment.

FIG. 12 is a block diagram of further example details for the satellite communication system introduced in FIG. 1.

FIG. 13 is a logic flow diagram of a method of operation by a satellite communication system, according to example embodiments.

FIGS. 14 and 15 are logic flow diagrams of methods of operation by a user terminal, according to example embodiments.

### DETAILED DESCRIPTION

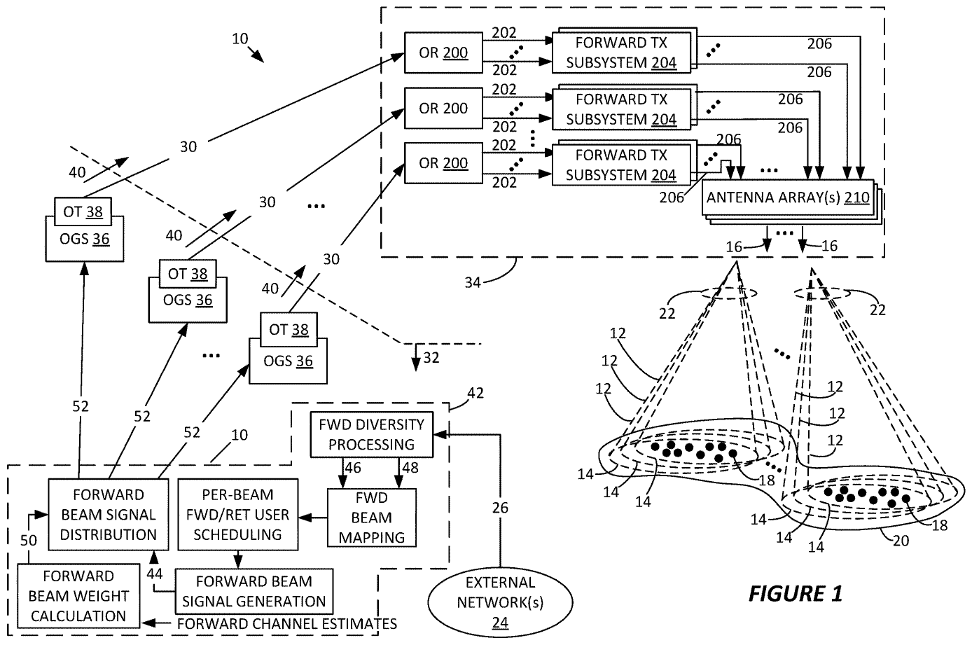

FIG. 1 illustrates a satellite communication system (SCS) 10 that provides a plurality of forward user beams 12, each having a corresponding forward user beam coverage area 14 and resulting from the beamformed transmission of a corresponding forward downlink signal 16. Each forward downlink signal 16 conveys scheduled forward user traffic for user terminals (UTs) 18 served by the corresponding forward user beam 12. For example, each forward downlink signal 16 carries forward user traffic scheduled for multiple UTs 18 according to a Time Division Multiple Access (TDMA) arrangement.

The overall aggregation of the forward user beam coverage areas 14 corresponds to a potentially large geographic region—an aggregate coverage area 20—over which the SCS 10 provides communication services. For example, the aggregate coverage area 20 spans at least a portion of North America or other geographic region. The aggregate coverage area 20 may be referred to as a satellite service area.

Among the plurality of forward user beams 12, there are one or more forward spatial diversity beam subsets 22. Each forward spatial diversity beam subset 22 comprises a subset of two or more forward user beams 12 having respective forward user beam coverage areas 14 that overlap by more than a threshold amount—i.e., a purposeful overlap that enables the SCS 10 to serve UTs 18 in the overlapped coverage areas via two or more forward user beams 12.

Serving a UT 18 via more than one forward user beam 12 is based on the forward user traffic targeted to that UT 18 being divided across two or more forward downlink signals 16 that are beamformed to yield respective forward user beams 12, where each such beam provides coverage with respect to the location of the UT 18. The respective beam coverage areas 14 may be defined in terms of Effective Isotropic Radiated Power (EIRP) contour lines, e.g., respective 3 dB contour lines.

The forward user beams 12 in each forward spatial diversity beam subset 22 have coextensive or substantially overlapping forward beam coverage areas 14, e.g., more than a fifty-percent overlap. In at least one embodiment, the forward user beams 12 in a forward spatial diversity beam subset 22 have the same nominal forward user beam coverage areas 14, although differences in coverage areas may exist in practice.

For beam signal separability in the overlapped forward beam coverage areas 14 of a given forward spatial diversity beam subset 22, the forward user beams 12 within the given forward spatial diversity beam subset 22 are in different downlink frequency bands or have different polarizations or both. In other words, the forward user beams 12 comprised in any given forward spatial diversity beam subset 22 have distinctive combinations of downlink signal frequency and polarization. Of course, the SCS 10 in one or more embodiments employs frequency and polarization reuse across the aggregate region 20 and the respective forward user beams 12 may be assigned frequencies and polarizations according to a reuse pattern that avoids or minimizes inter-beam interference over the aggregate coverage area 20. Thus, among the plurality of forward user beams 12 provided by the SCS 10 there may be multiple forward user beams 12 that use the same combination of downlink signal frequency and polarization, but these beams are not overlapping. Conversely, the forward user beams belonging to a forward spatial diversity beam subset 22 overlap to at least some extent but are distinguished from each other according to their respective frequency/polarization combination. The same arrangement may be used in the return direction, with respect to return user beam coverage areas that subdivide the satellite service area.

The SCS 10 may provide forward spatial diversity coverage over all portions of the aggregate region 20. Alternatively, there may be some portions of the aggregate region 20 having forward spatial diversity coverage via corresponding forward spatial diversity beam subsets 22, with other portions having only non-diversity coverage provided by respective single forward user beams 12.

The SCS 10 communicatively couples to one or more external networks 24, such as the Public Switched Telephone Network and the Internet or other packet data networks. User traffic incoming to the SCS 10 for delivery to respective UTs 18 comprises, for example, respective incoming user data streams 26. Each incoming user data stream 26 comprises, for example, data packets having a destination address identifying the targeted UT 18. In turn, the SCS 10 maintains information indicating the locations of each UT 18 or otherwise indicating which forward user beam(s) 12 are used or can be used for serving each UT 18. As such, the SCS 10 knows which forward user beam(s) 12 can be used to convey forward user traffic for a given UT 18 and it uses that knowledge to map scheduled forward user traffic for respective UTs 18 to respective ones among the plurality of forward user beams 12 provided by the SCS 10.

An advantageous processing function performed by the SCS 10 in one or more embodiments with respect to the incoming user data streams 26 is deciding whether to use forward spatial diversity transmission. Further, in at least one embodiment, the SCS 10 decides the “degree” of forward spatial diversity to apply, where “degree” refers to the number of forward user beams 12 to use for forward spatial diversity transmission of a particular incoming user data stream 26. Two forward user beams 12 represents a minimum degree of diversity, with three, four, or more beams representing higher degrees. For each incoming user data stream 26 transmitted using forward spatial diversity, the incoming user data stream 26 is divided into as many forward user data sub-streams as there are forward user beams 12 used for diversity.

As an example, assume that a given incoming user data stream 26 targets a UT 18 that is at a location covered by five forward user beams 12, each at a different forward downlink frequency and/or polarization. The “maximum” forward transmit diversity for the given incoming user data stream 26 therefore is a five-way division of the incoming user data stream 26 across the five forward downlink signals 16 corresponding to the five forward user beams 12. Thus, for this user data stream 26, the SCS 10 may use forward non-diversity transmission-a single forward user beam 12 conveys the incoming user data stream 26 targeting the UT 18, or the SCS 10 may use forward spatial diversity transmission-two or more forward user beams 12 each convey a respective forward user data sub-stream formed by dividing the incoming user data stream 26. In the forward spatial diversity transmission case, the SCS 10 in one or more embodiments may dynamically select the number of forward user beams 12 to include in the diversity forward transmission.

The decision to employ forward spatial diversity transmission or employ forward non-diversity transmission may be made on individual incoming user data streams 26 or on groups or classes of incoming user data streams 26. As one example, per user data stream decisions depend on user subscription agreements or other service agreements. As a particular example, the SCS 10 uses forward diversity transmission for incoming user data streams 26 that are prioritized or deemed more critical, according to subscription agreements. The decision may additionally or alternatively consider the involved communication services or service types, e.g., based on throughput requirements, criticality, or other Quality-of-Service (QoS) considerations. Additionally, or alternatively, the decision depends on atmospheric conditions bearing on the reliability of the forward uplinks 30 connecting a ground segment 32 of the SCS 10 to the involved satellite(s).

In this regard, FIG. 1 aids simplicity of discussion by illustrating a single satellite 34 providing a plurality of forward user beams 12. However, the SCS 10 shall be understood as including one or more satellites 34, each providing a potentially large plurality of forward user beams 12. In at least one embodiment, the SCS 10 includes one or more constellations of satellites 34. Each such satellite 34 is a geosynchronous satellite in at least one embodiment and the corresponding forward user beam coverage areas 14 are fixed, at least nominally. In one or more embodiments, each such satellite 34 is a bent-pipe satellite that uses non-processed signal paths for relaying user traffic in the forward and/or return directions. A “non-processed” signal path may include conversion between the electrical and optical domains and may include filtering, amplification, and frequency shifting, but it excludes demodulation and regeneration of the user traffic.

To the extent that a given UT 18 is within the overlapping forward beam coverage areas 14 of two or more forward user beams 12—i.e., its location lies within the coverage provided by a forward spatial diversity beam subset 22—the SCS 10 may choose to serve the given UT 18 using a single forward user beam 12 or using two or more forward user beams 12.

A key aspect of forward spatial diversity as that term is used herein is that each forward user data sub-stream divided out from any given incoming user data stream 26 is transported from the ground segment of the SCS 10 to the space segment of the SCS 10 via a different optical feeder link 30. This approach, combined with the encoding and dividing used to form the respective forward user data sub-streams allows the targeted UT 18 to recover the full user data stream, even if the individual optical feeder links 30 involved in the transport of the respective forward user data sub-streams experience temporary impairments. In this regard, because different ground stations 36 in the ground segment provide the different optical feeder uplinks 30 and because the different ground stations 36 are geographically distributed, atmospheric-related impairments affecting one optical feeder uplink 30 are uncorrelated from atmospheric-related impairments affecting the other optical feeder uplinks 30.

The ability to use forward spatial diversity offers numerous advantages, particularly in the context of using optical feeder uplinks 30 between the satellite(s) 34 of the SCS 10 and respective ground stations 36. With free space optical feeder uplinks 30 individually vulnerable to temporary impairments, the problem of dropped or interrupted communications is mitigated by distributing an incoming user data stream 26 across multiple optical feeder uplinks 30 using a data-division approach that allows Forward Error Correction (FEC) based recovery of the full stream at the targeted UT 18 even during instances when fewer than all forward user data sub-streams are successfully received.

In FIG. 1, each ground station 36 is labeled “OGS” to denote “Optical Ground Station.” Each ground station 36 includes one or more optical transmitters (“OT”) 38, with each optical transmitter 38 anchoring a corresponding one of the optical feeder uplinks 30, with each optical feeder uplink 30 targeting a particular satellite 34. More particularly, each optical transmitter 38 in each ground station 36 transmits a respective optical forward uplink signal 40 conveying one or more forward beam signals. Each forward beam signal carries scheduled forward user traffic corresponding to individual UTs 18 being served by the forward user beam 12 corresponding to the forward user beam signal.

Employing forward spatial diversity transmission means that each forward user data sub-stream divided from a given incoming user data stream 26 is carried by a different forward beam signal and further means that each forward user beam signal is transmitted by a different ground station 36, such that optical impairment interfering with the transmission of one of the forward beam signals are uncorrelated from optical impairments interfering with transmission of the other one(s) of the forward beam signals. With the foregoing definition, “forward feeder link spatial diversity” is an equivalent term, describing the process by which forward user data sub-streams divided out from a given incoming user data stream 26 and are conveyed from the ground segment to the space segment using different optical feeder uplinks 30 provided by different ground stations 36. Here, the geographic separation between the ground stations 36 provides at least some of the “spatial diversity.” Further spatial diversity arises in the case where different satellites 34 in the space segment are used to transmit the different forward user beams 12 that carry the respective forward user data sub-streams.

A communications and control subsystem (CCS) 42 included in the ground segment 32 of the SCS 10 comprises one or more computer servers or other physical computing platforms configured to carry out certain forward transmission processing, including the generation of forward beam signals 44 that are distributed to the respective ground stations 36.

As such, the CCS 42 may be understood as comprising a processing node. Reference here to a “processing node” should be interpreted broadly as encompassing single-node or multi-node embodiments, such as where physically separate but communicatively linked nodes operate cooperatively. The processing node comprise, for example, processing circuitry and one or more types of communication interfaces for exchanging signaling with other entities in the SCS 10, such as respective ground stations 36. In at least one embodiment, the CCS 42 comprises one or more microprocessors that are specially adapted based on the execution of stored computer program instructions, to carry out the CCS functions described herein. In such embodiments, the CCS 42 includes storage comprising one or more types of computer readable media for storage of the computer program instructions.

Each ground station 36 corresponds to a particular forward downlink frequency and polarization combination. More particularly, each ground station 36 transmits one or more sets or pluralities of forward beam signals in each optical forward uplink signal 40 transmitted by it. Each set or plurality of forward beam signals corresponds to a set or plurality of forward user beams 12 having a same downlink signal frequency and polarization and is carried in a different segment of the overall optical spectrum occupied by the forward uplink signal 40. Although the same reference number “44” is used for all forward beam signals for clarity, it should be appreciated that the user traffic carried in one forward beam signal 44 differs from the user traffic carried in another one, and that each forward beam signal 44 corresponds to a different one among the overall plurality of forward user beams 12 provided by the SCS 10.

According to the illustrated embodiment of the SCS 10, the CCS 42 receives incoming user data streams 26 from the external network(s) 26 and performs forward diversity processing. Such processing includes deciding whether to employ forward spatial diversity transmission or forward non-diversity transmission. In at least one such embodiment, the decision making further includes deciding the degree of forward spatial diversity to use. These decisions may be made on a per stream basis or may be made for groups of incoming user data streams 26, or with respect to all incoming user data streams 26.

The CCS 42 may make the decisions, for example, based on prevailing conditions, such as whether weather impairments are detected or expected for one or more of the optical forward uplinks 30. For example, in at least one embodiment, the SCS 10 operates modally by selecting between a diversity mode in which it employs forward spatial diversity for at least some incoming user data streams 26 and a non-diversity mode in which it does not employ forward spatial diversity. Further, in at least one embodiment, the SCS 10 omits the decision-making operations and employs forward spatial diversity for all incoming user data streams 26. As such, saying that the SCS 10 “employs forward spatial diversity for at least one incoming user data stream 26” shall be understood as meaning that under at least some conditions or in at least one embodiment, the SCS 10 employs forward spatial diversity for transmitting one or more of the incoming user data streams 26.

According to the example of FIG. 1, for any incoming user data streams 26 transmitted without forward spatial diversity, the CCS 42 passes them as forward user data streams 46 to a forward beam mapping function implemented via processing circuitry of the CCS 42. The incoming user data streams 26 to be transmitted with forward spatial diversity are divided into respective forward user data sub-streams 48, which are passed to the forward beam mapping function. Here, it should be noted that the forward user data streams 46 may comprise block encoded versions of the corresponding incoming user data streams, based on applying a defined block code having a defined block length, and for any incoming user data stream 26 to be transmitted using forward spatial diversity, the corresponding forward user data stream 46 may be divided such that a different portions of encoded data from each encoded block form the respective forward user data sub-streams 48.

Each forward user data stream 46 targets a particular UT 18 and is mapped to a forward user beam 12 used to serve that UT 18. Likewise, each forward user data sub-stream 48 is mapped to a respective forward user beam 12 in the forward spatial diversity subset 22 that is associated with serving the targeted UT 18. Each forward user beam 12 may carry a mix of forward user data streams 48 for UTs 18 being served via non-diversity forward transmission and forward user data sub-streams 48 for UTs 18 being served via diversity forward transmission. Broadly, all such traffic may be referred to as forward user traffic or scheduled forward user traffic, with the understanding that forward user traffic is beam specific. Notably, the respective forward user data sub-streams 48 being used to serve any particular UT 18 via forward spatial diversity are each conveyed by a different forward user beam 12, meaning that they are mapped to different forward beam signals 44 by the ground segment.

Traffic-to-beam mapping happens on an ongoing basis, with respect to the data flows constituting the individual incoming user data streams 26 and the forward beam mapping function of the CCS 42 logically groups the forward user data streams 46 and forward user data sub-streams 48 according to the respective forward user beams 12 in which they are transmitted. From there, a forward user scheduling function performs ongoing multiplexing of the forward user data streams 46 and forward user data sub-streams 48 for each forward user beam 12, according to a user scheduling algorithm.

A forward beam signal generation function implemented via processing circuitry of the CCS 42 forms a plurality of forward beam signals 44, with the plurality of these individual forward beam signals 44 graphically represented by the signal line “44” output from the forward beam signal generation function. Each forward beam signal 44 corresponds to a particular one of the forward user beams 12. That is, each forward downlink signal 16 results from the beamformed transmission of a respective one of the forward beam signals 44. Here, “beamformed” transmission refers to the transmission of a set of forward beam element signals from a targeted satellite antenna array, each forward beam element signal in the set modulated according to the forward beam signal 44 in question and weighted for transmission from a respective antenna element in the antenna array according to a respective forward beam weight from a corresponding set of forward beam weights calculated from Channel State Information (CSI)—e.g., propagation channel estimates—describing the forward paths from the targeted antenna array to one or more UTs 18 in the forward user beam coverage area 14 of the forward user beam 12 corresponding to the forward beam signal 44.

For each forward beam user signal 44, simultaneous transmission of the corresponding set of forward beam element signals from the targeted satellite antenna array can be understood as the beamformed transmission of the corresponding forward downlink signal 16 and the element signal weightings result in a pattern of constructive and destructive superpositions of the forward downlink signal 16 in the far field that results in the corresponding forward user beam 12—here, “far field” refers to the electromagnetic field region where radiative behavior dominates.

FIG. 1 illustrates the foregoing details by depicting each forward beam signal 44 as having a corresponding set of forward beam weights 50 determined by a forward beam weight calculation function that is implemented via processing circuitry of the CCS 42. Note that use of the reference number “50” in FIG. 1 is in a plural sense, meaning that there is a set of forward beam weights 50 for each forward beam signal 44. Forward beam weights 50 are calculated with respect to each forward user beam 12 using, for example, channel feedback from one or more UTs 18 operating in the corresponding forward user beam coverage areas 14. Thus, the forward beam weight calculation function in one or more embodiments uses forward channel estimates to calculate the corresponding set of forward beam weights 50 for each forward beam signal 44.

A forward beam signal distribution function implemented via processing and communication interface circuitry of the CCS 42 distributes the forward beam signals 44 and additional corresponding information, such as the sets of forward beam weights 50, to the respective ground stations 36. FIG. 1 uses the reference numeral 52 to denote the distribution of the forward beam signals 44 with the additional corresponding information. That is, each “signal 52” shall be understood as being one or more sets of forward beam signals 44, along with the corresponding sets of forward beam weights 50. Again, each “set” of forward beam signals 44 sent to a respective ground station 36 represents one or more forward user beams 12 having a same downlink signal frequency and polarization and transmitted from a same satellite antenna array.

In an example arrangement, each ground station 36 handles one or more sets of forward beam signals 44 corresponding to one or more sets of forward user beams 12 from among the overall plurality of forward user beams 12 provided by the SCS 10. The distribution of respective forward beam signals 44 by the CCS 42 to the ground stations 36 may be based on such associations. However, such associations may be changed from time to time, e.g., to account for failed ground stations 36 or maintenance, or other availability or load-balancing considerations, with the distribution updated to reflect the changes. However, for any given forward spatial diversity beam subset 22, each included forward beam 12 is handled by a different ground station 12, at least when forward spatial diversity is employed.

In at least one embodiment, one or more of the ground stations 36 may transmit more than one optical forward uplink signal 40, using respective optical transmitters 38. In any case, each optical forward uplink signal 40 conveys one or more sets of forward beam signals 44, with each such set representing a corresponding set of forward user beams 12 and being carried within a respective segment of the overall optical spectrum spanned by the forward uplink signal 40. More particularly, in at least one embodiment, each “set” of forward beam signals 44 conveyed in any given optical forward uplink signal 40 transmitted by any given ground station 36 corresponds to forward user beams 12 having the same downlink signal frequency and polarization. Moreover, each such set of forward beam signals 44 targets the same antenna array onboard the satellite targeted by the forward uplink signal 40 and is carried in a respective segment of the overall optical spectrum of the forward uplink signal 40. This approach reduces beamforming complexity in the ground stations 36 and simplifies the electro-optical conversion and multiplexing used to form the optical forward uplink signal 40, and the optical bandwidth of each forward uplink signal 40 means that each forward uplink signal 40 may carry multiple sets of forward beam signals 44 corresponding to potentially many forward user beams 12, e.g., hundreds of forward user beams 12.

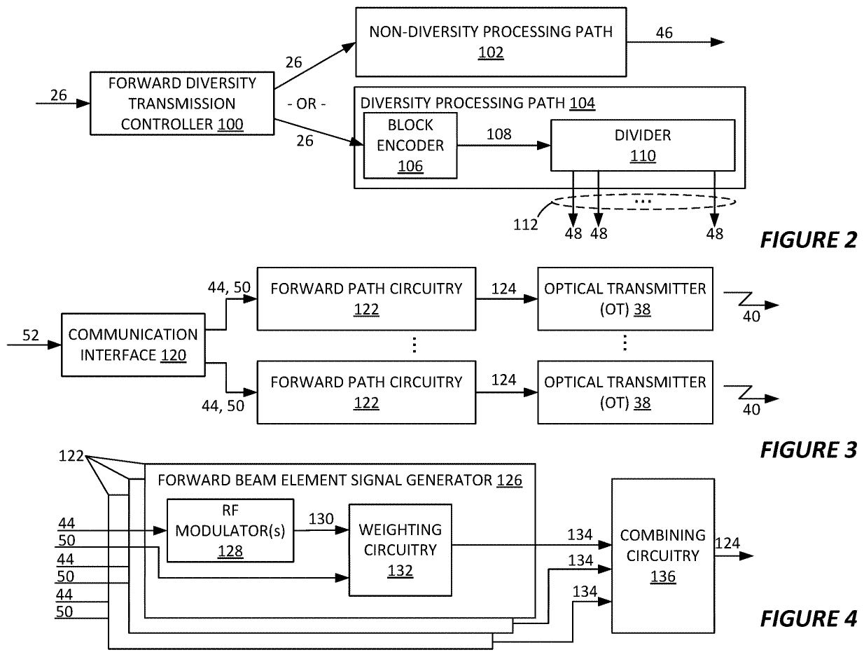

FIG. 2 illustrates an implementation of forward diversity processing by the CCS 42 in one embodiment. The diagram illustrates processing for a given incoming user data stream 26, with the understanding that the CCS 42 includes additional signal paths and processing to apply the same treatment to all incoming user data streams 26. In other words, the CCS 42 is configured to process a plurality of incoming user data streams 26 in parallel.

A forward transmission diversity controller 100 decides whether to apply forward spatial diversity for the incoming user data stream 26, and correspondingly routes each incoming user data stream 26 either to a non-diversity processing path 102 or a diversity processing path 104. The diversity processing path 104 includes a block encoder 106 that performs block encoding of the incoming user data stream 26 and outputs a corresponding forward stream of encoded blocks 108.

A divider 110 divides each encoded block 108 into respective sub blocks, each containing a different subset of the encoded data comprised within the encoded block 108. This operation creates corresponding streams of sub blocks 112, each containing different encoded data, with these streams of sub blocks 112 comprising the forward user data sub-streams 48 used for forward spatial diversity transmission of the associated incoming user data stream 26. The number of forward user data sub-streams 48 formed from a given incoming user data stream 26 represents the diversity degree—i.e., the number of separate forward user beams 12 used to convey the incoming user data stream 26 to the targeted UT 18.

In at least one embodiment, the CCS 42 applies the same block encoding to each incoming user data stream 26, regardless of whether the incoming user data stream 26 is transmitted using forward spatial diversity. That is, the CCS 42 performs block encoding of every incoming user data stream 26 to form corresponding forward user data streams 46 and then, for each forward user data stream 46 transmitted using forward spatial diversity, the CCS 42 performs the encoded-block divisions that yield the corresponding set of forward user data sub-streams 48. Forward diversity processing by the CCS 42 therefore outputs a forward user data stream 46 for incoming user data streams 26 that are not diversity transmitted, and outputs corresponding sets of forward user data sub-streams 48 for incoming user data streams 26 that are diversity transmitted.

FIG. 3 illustrates an example arrangement for a ground station 36, including a communication interface 120 that is configured to receive a signal 52 from the CCS 42, comprising one or more sets of forward beam signals 44 and the corresponding sets of forward beam weights 50. The ground station 36 may include more than one optical transmitter 38, and the signal 52 incoming from the CCS 42 may include one or more sets of forward beam signals 44 for transmission from each respective optical transmitter 38.

The communication interface 120 comprises physical-layer receiver circuitry, along with timing and communications processing, and it the outputs forward beam signals 44 to be transmitted via a particular optical transmitter 38 to corresponding forward path circuitry 122. There is a collection of forward path circuitry 122 associated with each optical transmitter 38 included in the ground station, with the circuitry configured to provide signal processing with respect to the particular sets of one or more forward beam signals 44 to be transmitted by the associated optical transmitter 38. The collection of forward path circuitry 122 associated with each optical transmitter 38 generates a set of combined forward beam element signals 124 for each set of forward beam signals 44 to be conveyed in the forward signal 40 output by the optical transmitter 38. Thus, it should be understood that each collection of forward path circuitry 122 receives one or more sets of forward beam signals 44, with each such set containing at least one forward beam signal 44, and with a corresponding set of forward beam weights 50 received for each such forward beam signal 44.

FIG. 4 illustrates example details for the forward path circuitry 122 associated with each optical transmitter 38, according to one embodiment. More particularly, FIG. 4 illustrates circuitry used for each respective set of forward beam signals 44 to be transmitted in the same forward uplink signal 40. For each forward beam signal 44 in each set there is a forward beam element signal generator 126. Although FIG. 4 suggests three forward beam element signal generators 126 for an example set of three individual forward beam signals 44, it will be appreciated that with respect to each optical transmitter 38 included in each ground station 36, there may be a defined number of forward beam element signal generators 126 corresponding to the maximum number of forward beam signals 44 that can be transmitted via the corresponding forward uplink signal 40.

Each forward beam element signal generator 126 operates on a respective forward beam signal 44 in the involved set and includes a plurality of radio frequency modulators 128 or, equivalently, a RF modulator and a signal splitter. Each forward beam element signal generator 126 is configured to output a set of RF signals 130. Each RF signal 130 corresponds to a respective antenna element of a targeted satellite antenna array that is used to form the forward user beam 12 corresponding to the forward beam signal 44 being processed. The RF signals 130 are formed by modulating a RF carrier according to the forward beam signal 44, and they all may be at the same frequency, e.g., a given intermediate frequency. Weighting circuitry 132 applies the corresponding set of forward beam weights 50 to the set of RF signals 130, to form a set of forward beam element signals 134. The corresponding set of forward beam weights 50 is calculated such that simultaneous transmission of the set of forward beam element signals 134 from the corresponding antenna elements of the targeted satellite antenna array results in signal superpositions that form the corresponding forward user beam 12 in the far field.

As shown, a set of forward beam element signals 134 is generated for each forward beam signal 44 in each set of forward beam signals 44 that is to be transmitted by the optical transmitter 38. Combining circuitry 136 combines corresponding ones among the respective sets of forward beam element signals 134 to obtain the corresponding set of combined forward beam element signals 124. The combining occurs on a per-element basis, such that the forward beam element signals 134 from each of the sets that map to the same antenna element in the targeted antenna array are combined. These linear combinations are possible because the forward beam signals 12 corresponding to the sets of forward beam element signals 134 being combined all have the same downlink signal frequency and polarization.

For example, assume that there are four forward beam signals 44 in a given set of forward beam signals 44 being processed by the ground station 36 with respect to a particular optical transmitter 38 in the ground station 36, and that there are one hundred antenna elements in the targeted satellite antenna array. The ground station 36 generates one hundred forward beam element signals 134 for each forward beam signal 44 being processed, based on a corresponding set of one hundred forward beam weights 50. For the i-th antenna element in the targeted satellite antenna array, there are four i-th forward beam element signals 134, one for each of the forward beam signals 44 and these four forward beam element signals 130 are added together to yield a corresponding combined forward beam element signal 124 for the i-th antenna element. Of course, if there is only one forward beam signal 44 in a “set” of forward beam signals 44, the set of combined forward beam element signals 124 output from the combining circuitry 136 is merely the one set of forward beam element signals 134 generated for the one forward beam element signal 44.

From FIG. 4, then, each forward uplink signal 40 conveys one or more sets of forward beam signals 44. Each such set of forward beam signals 44 is represented by a set of combined forward beam element signals 124. The set of combined forward beam element signals 124 is obtained by combining the individual sets of forward beam element signals 134 that are generated for individual forward beam signals 44 included in the set of forward beam signals 44.

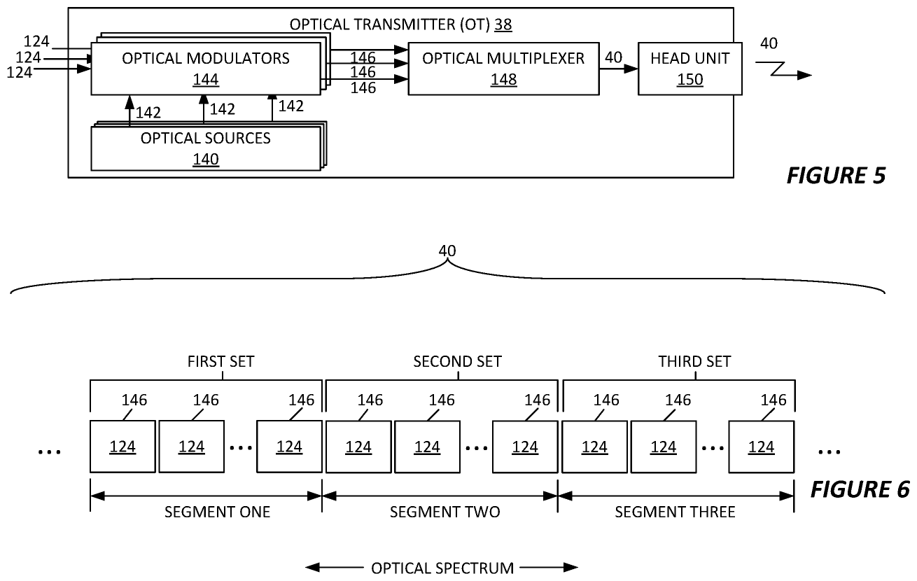

FIG. 5 illustrates an optical transmitter 38 according to one embodiment. For simplicity of illustration, the diagram assumes that there are three sets of forward beam signals 44 to be transmitted, with each such set represented by a respective set of combined forward beam element signals 124 incoming to the optical transmitter 38. Of course, there may be many such sets of forward beam signals 44, with each set containing one or more forward beam signals 44, such that the overall optical spectrum of the forward uplink signal 40 is efficiently utilized.

Each set of combined forward beam element signals 124 feeds into a respective set of optical modulators 144. Within each such optical modulator 144, each one of the combined forward beam element signals 124 is used to modulate a corresponding optical carrier 142 among a plurality of optical carriers 142 provided by a plurality of optical sources 140. With respect to each set of combined forward beam element signals 124, the corresponding set of optical carriers 142 are at different optical wavelengths defining a respective optical channel. Moreover, the respective sets of optical sources 140 each output their respective set of optical carriers 142 in a different portion of optical spectrum—i.e., each set of optical carriers 142 corresponds to a different set of optical channels. As such, each set of forward beam signals 44 being transmitted is represented by a different set of combined forward beam element signals 124, with each such set of combined forward beam element signals 144 carried in a different set of optical channel signals 146.

Each optical channel signal 146 in each set of optical channel signals 146 conveys a respective one among the corresponding set of the combined forward beam element signals 124 used to generate the set of optical channel signals. As the combined forward beam element signals 124 are RF signals, one approach is to intensity-modulate the optical carriers 142, such that the intensity variations of each resulting forward optical channel signal 146 conveys the corresponding combined forward beam element signal 124. In at least one embodiment, phase modulation is used, wherein the phase of each optical carrier 142 is modulated according to a respective one of the combined forward beam element signals 124. Broadly, each forward optical channel signal 146 conveys the user traffic contained in the forward beam signal(s) 44 for which the corresponding combined forward beam element signal 124 was formed.

FIG. 6 illustrates an example arrangement for forming an forward uplink signal 40 as a multiplexed optical signal. The example assumes that there are three sets of forward beam signals 44 to be conveyed in the forward uplink signal 40, with each such set comprising one or more forward beam signals 44, and where the forward beam signals 44 included in each such set corresponding to forward user beams 12 having the same downlink signal frequency and polarization. Each set of forward beam signals 44 is used to generate a corresponding set of combined forward beam element signals 124, and each set of combined forward beam element signals 124 is conveyed in a corresponding set of forward optical channel signals 146.

In more detail, “SEGMENT ONE” of the optical spectrum illustrated in FIG. 6 contains a first set of forward optical channel signals 146, conveying a first set of combined forward beam element signals 124, which corresponds with a first set of forward beam signals 44 representing a first set of forward user beams 12. “SEGMENT TWO” of the optical spectrum contains a second set of forward optical channel signals 146, conveying a second set of combined forward beam element signals 124, which corresponds with a second set of forward beam signals 44 representing a second set of forward user beams 12. “SEGMENT THREE” of the optical spectrum contains a third set of forward optical channel signals 146, conveying a third set of combined forward beam element signals 124, which corresponds with a third set of forward beam signals 44 representing a third set of forward user beams 12. There may be as many additional sets of forward optical channel signals 146 as will fit within the overall span of spectrum allotted for the forward uplink signal 40.

As such, the forward uplink signal 40 effectively “stacks” the respective sets of combined forward beam element signals 124 in the optical frequency domain using Dense Wavelength Division Multiplexing (DWDM). This approach allows but does not require that all combined forward beam element signals 124 in each such set be at the same RF frequency, which may the downlink signal frequency used by the forward user beams 12 represented in the set of combined forward beam element signals 124 or may be some intermediate frequency, e.g., 3.5 GHz.

As shown in FIG. 5, an optical multiplexer 148 in the optical transmitter 38 forms the forward uplink signal 40 as an aggregation of such sets of forward optical channel signals 146, and an optical head unit 150 focuses or otherwise guides the forward uplink signal 40 for transmission toward the targeted satellite 34. As noted, the head unit 150 focuses or otherwise orients the forward uplink signal 40 for free-space transmission toward an optical receiver of the targeted satellite 34. As one example, the head unit 150 comprises one or more mirrors. As another example, the head unit comprises one or more prisms. In at least one embodiment, the head unit 150 is steerable responsive to steering command signals, with steering allowing the head unit 150 to be adjusted for alignment with respect to a targeted optical receiver on a targeted satellite 34.

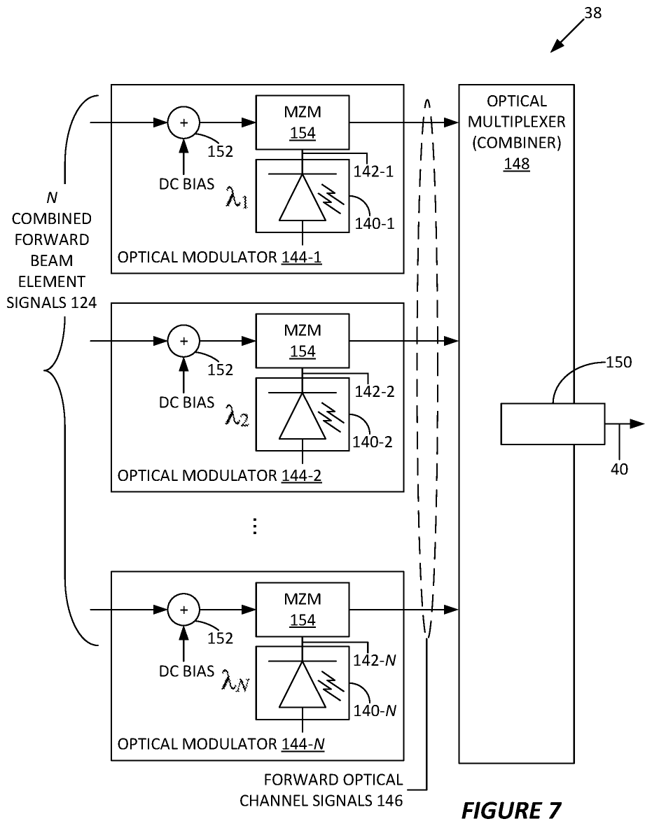

FIG. 7 illustrates further example details for an optical transmitter 38, according to one embodiment. FIG. 7 is simplified to show implementation details with respect to only a single set of combined forward beam element signals 124 carrying one corresponding set of forward beam signal(s) 44 to be conveyed in the forward uplink signal 40 output by the optical transmitter 38. However, it should be understood that the optical transmitter 38 includes modulation circuitry for each set of combined forward beam element signals 124 being handled by the optical transmitter 38.

In FIG. 7, a first one of the depicted combined forward beam element signals 124 serves as the modulation input for a first optical modulator 144-1, a second one of the combined forward beam element signals 124 serves as the modulation input for a second optical modulator 144-2, and so on. Each optical modulator 144 includes, for example, a bias circuit 152 to apply a DC bias to the corresponding combined forward beam element signal 124 input into it, with the DC-biased signal then applied to a modulator 154. The modulator 154 is, for example, a Mach-Zehnder Modulator (MZM) that modulates an optical carrier 142 output from an optical source 140, such as a laser diode outputting light a specific optical wavelength. As noted, the modulation in one or more embodiments is phase modulation. Intensity modulation also may be used.

Turning back to FIG. 1, each satellite 34 has one or more optical receivers (“OR”) 200 onboard. Each optical receiver 200 is configured to receive a respective forward uplink signal 40 from a respective optical transmitter 38 of a respective ground station 36. As with the optical transmitters 38, the optical receivers 200 are steerable in one or more embodiments, and it shall be understood that a given optical receiver 200 on a given satellite 34 may be aligned with different optical transmitters 38 in the same or different ground stations 36 at different times. Steering may be used for load balancing or to accommodate ground station maintenance or failures or prevailing weather conditions, or for other reasons.

Each optical receiver 200 outputs a set of recovered RF signals 202 corresponding to each set of combined forward beam element signals 124 conveyed in the received forward uplink signal 40. That is, for each set of forward beam signals 44 conveyed in the forward beam signal 44, the optical receiver 200 recovers a corresponding set of RF signals 202 comprising the recovered version of the set of combined forward beam element signals 124 generated in the transmitter from the set for forward beam signals 44. Each signal line in FIG. 1 that is labeled “202” shall be understood as representing a set of recovered RF signals 202.

Such operations are based on demultiplexing the received forward uplink signal 40 in the optical domain to recover the respective sets of forward optical channel signals 146 conveyed by the forward uplink signal 40. Each recovered forward optical channel signal 146 is then demodulated—e.g., using a photo detector to track, for example, phase modulations of the recovered forward optical channel signal 146—to produce a corresponding one of the recovered RF signals 202. Use of the reference number 202 in the receiver context rather than the number 124 as used in the transmitter context is done merely to emphasize transmitter versus receiver context. Absent disturbances or corruption, each set of RF signals 202 recovered from a received forward uplink signal 40 are, in terms of information content, identical to the corresponding set of combined forward beam element signals 124 multiplexed into the forward uplink signal 40 at the corresponding optical transmitter 38.

A forward transmit (TX) subsystem 204 couples each set of recovered RF signals 202 to one among one or more antenna arrays 210 onboard the satellite 34. Each forward TX subsystem 204 takes in a respective set of recovered RF signals 202 and outputs a corresponding set of forward antenna element signals 206. Each signal line in FIG. 1 that is labeled “206” shall be understood as representing a set of forward antenna element signals 206.

Each set of forward antenna element signals 206 differs from its corresponding set of recovered RF signals 202 in terms of any one or more of amplification, filtering, and frequency translation. In at least one embodiment, each set of recovered RF signals 202 is at IF and the forward TX subsystem 204 corresponding to each such set translates those signals to a downlink signal frequency used for the forward user beam(s) 12 represented in the set. In one or more embodiments, therefore, each forward TX subsystem 204 is associated with a particular antenna array 210 and/or a particular set of antenna input feeds having an associated downlink signal frequency and polarization, with each forward TX subsystem 204 comprising a set of forward analog signal paths that provide at least power amplification for a respective set of recovered RF signals 202, for transmission of those signals from respective array elements of the associated antenna array 210.

The satellite 34 may have a single antenna array 201 having different sets of input feeds associated with different downlink signal frequencies and polarizations, such that forward user beams 12 of different downlink signal frequencies and polarizations are transmitted from the same antenna array 210. For example, each optical receiver 200 receives a respective forward uplink signal 40 conveying one or more sets of forward beam signals 44, each such set associated with one or more forward user beams 12 having a particular downlink signal frequency and polarization combination, with all forward TX subsystems 204 applying the corresponding sets of forward antenna element signals 206 to different sets of input feeds of the same antenna array 210. Alternatively, the satellite 34 includes multiple antenna arrays 210, each associated with one or more particular downlink signal frequency and polarization combinations, with the respective forward TX subsystems 204 being associated with respective ones of the antenna arrays 210 according to the frequency and polarization relationships.

Broadly, with each set of forward antenna element signals 206 corresponding to one or more forward user beams 12 having a particular downlink carrier frequency and/or polarization, each forward TX subsystem 204 couples its output set of forward antenna element signals 206 to a set of antenna feeds corresponding to that particular frequency and/or polarization.

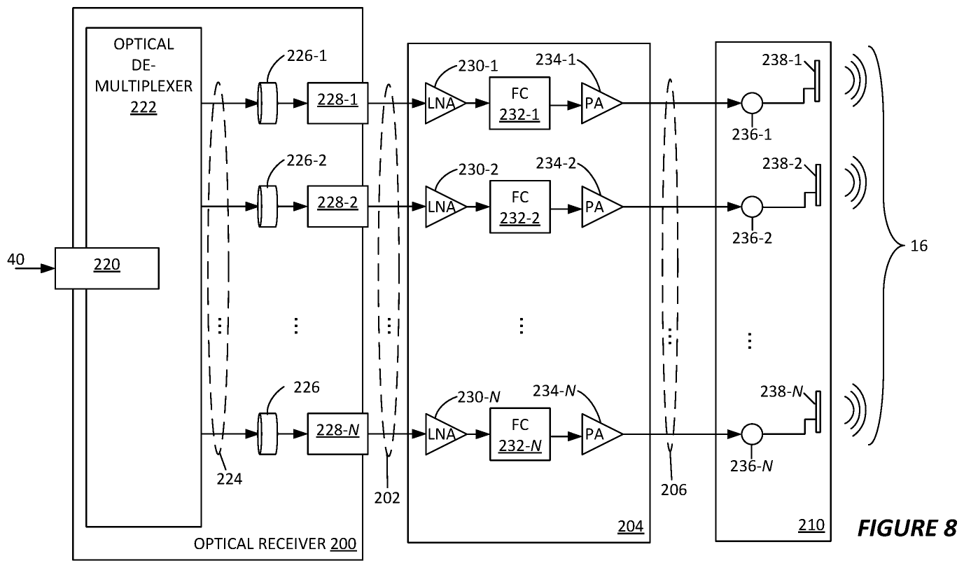

FIG. 8 illustrates example details for a given optical receiver 200 onboard a given satellite 34, for reception of a corresponding forward uplink signal 40. An optical head 220—e.g., one or more lenses and/or mirrors—receives a forward uplink signal 40 from a respective ground station 36 and an optical de-multiplexer 222 uses wavelength-division demultiplexing to recover one or more sets of forward optical channel signals 224 corresponding to the set of forward optical signals 146 multiplexed in the received forward uplink signal 40. For simplicity, FIG. 8 illustrates the recovery of a single set of forward optical channel signals 224 corresponding to one set of combined forward beam element signals 124, with that set of combined forward beam element signals 124 representing one set of forward beam signals 44.

With respect to FIG. 6, which shows multiple spectrum segments within the forward uplink signal 40 containing respective sets of forward optical channel signals 146, FIG. 8 can be understood as illustrating the recovery and demultiplexing of one such set. Correspondingly, it should be understood that additional like circuitry within the optical receiver 200 and additional forward TX subsystems 204 are included, for recovery of additional sets of forward optical channel signals 146 from the received forward uplink signal 40, and the corresponding recovery of corresponding sets of RF signals 202 and generation of corresponding sets of forward antenna element signals 206. Each set of forward antenna element signals 206 represents a corresponding set of one or more forward user beams 12, with each such beam conveying the traffic contained in the corresponding forward beam signal 44.

Regarding the forward optical channel signals 146, use of the reference number “224” in the receiver context rather than the number “146” merely emphasizes the receiver context versus the transmitter context. Absent disturbances or corruption, each set of forward optical channel signals 224 demultiplexed at the optical receiver 200 is, in terms of information content, identical to the corresponding set of forward optical channel signals 146 multiplexed at the corresponding optical transmitter 38.

Secondary lenses or mirrors 226 may be used to direct the respective optical channel signals 224 into corresponding photo diodes 228, e.g., a first one of the optical channel signals 224 is directed via a lens 226-1 into a photo diode 228-1, a second one of the optical channel signals 224 is directed via a lens 226-2 into a photo diode 228-2, and so on. Each photo diode 228 outputs an electrical signal responsive to the phase or intensity of the corresponding optical channel signal. These output electrical signals are the recovered RF signals 202 described above.

The forward TX subsystem 204 in the depicted embodiment include an analog forward signal pathway for each RF signal 202. Each forward signal pathway includes, for example, a Low Noise Amplifier (LNA) 230, a Frequency Converter (FC) 232, and a Power Amplifier (PA) 234. The FCs 232 translate the RF signals 202 from an intermediate frequency to a downlink carrier frequency associated with the targeted forward user beam(s) 12. The FCs 232 may be implemented either as upconverters or downconverters, in dependence on the involved frequencies.

The PAs 234 provide power amplification for the frequency-translated RF signals 202, with the power-amplified signals output from the PAs 234 referred to as a set of forward antenna element signals 206. The set of forward antenna element signals 206 are applied to a set of input feeds 236 of an antenna array 210 onboard the satellite 34, with each of those input feeds 236 corresponding to a respective antenna element 238 of the antenna array 210. Each antenna element 238 radiates the respective forward beam element signal 206 applied to its corresponding input feed 236, and collective transmission of these per-element signals can be regarded as transmission of the corresponding forward downlink signal(s) 16, with the far-field superpositions of the per-element signals yielding the corresponding forward user beam(s) 12.

To appreciate these results, recall that the forward uplink signal 40 received by the optical receiver 200 conveyed one or more sets of combined forward beam element signals 124, with each set of combined forward beam element signals 124 formed by combining two or more sets of forward beam element signals 134. Each such set of forward beam element signals 134 was weighted by a corresponding set of forward beam weights 50 calculated such that simultaneous transmission of the set of forward beam element signals 134 from respective antenna elements 238 of a targeted satellite antenna array 210 results in far-field signal superpositions that form a particular one of the forward user beams 12 provided by the SCS 10. Thus, transmitting a set of forward antenna element signals 206 formed from the satellite-recovered version of a set of combined forward beam element signals 124 yields the respective forward user beams 12 represented in the set of forward combined beam element signals 124.

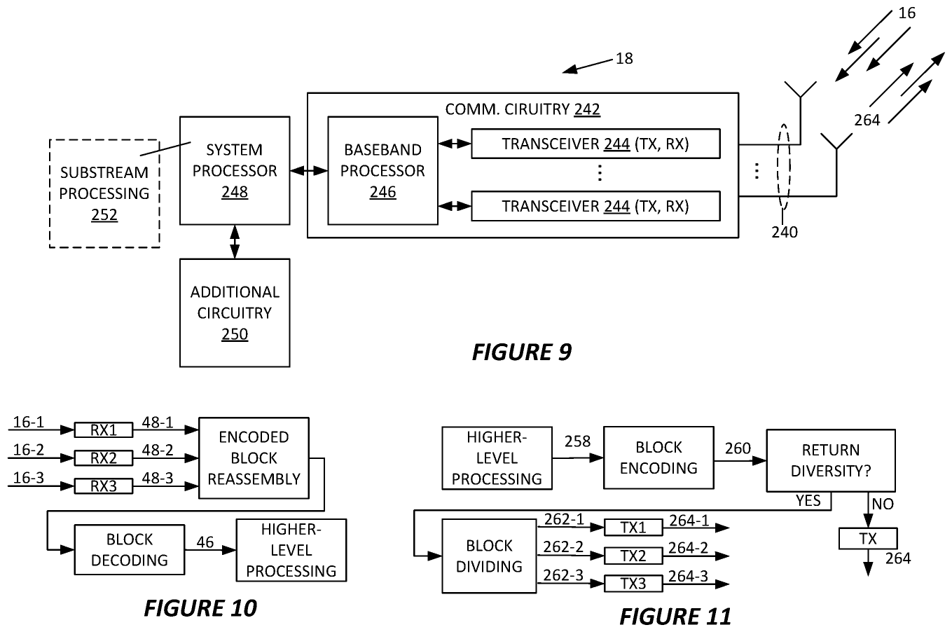

FIG. 9 depicts a UT 18 according to an example embodiment, where the UT 18 comprises one or more transmit/receive antennas 240 and associated communication circuitry 242. The communication circuitry 242 includes two or more transceiver signal chains 244, each including a satellite radio receiver or transmitter or both, along with a baseband processor 246 that provides transmit and receive signal processing and control. The example UT 18 further includes a system processor 248 that governs overall UT operation and, for example, executes one or more applications that yield the intended functionality of the UT 18. Example functionality includes telecommunications service, broadband multimedia delivery, etc. The UT 18 may include additional circuitry 250 in support of its intended functionality.

The system processor 248 and/or the baseband processor 246 implement a sub-stream processing function 252 that provides for processing of forward user data sub-streams in a diversity forward transmission context and/or provides for processing of return user data sub-streams in a diversity return transmission context, or both. The system processor 248 and the baseband processor 246 comprise one or more microprocessors, digital signal processors, FPGAs, ASICs, SoCs, or other digital processing circuits, with supporting clock circuitry, computer-readable storage media, etc.

FIG. 10 illustrates example sub-stream processing at the UT 18 for the diversity forward transmission case, while FIG. 11 illustrates example sub-stream processing at the UT 18 for the diversity return transmission case.

FIG. 10 uses the example of a forward user data stream 46 targeting the UT 18 having been divided into three forward user data sub-streams 48, shown as 48-1, 48-2, and 48-3. As a reminder with reference to FIG. 1, a forward user data stream 46 may be understood as the encoded, beam-mapped, and scheduled forward user traffic from an incoming user data stream 26.

An example UT 18 in one or more embodiments uses separate receiver circuitry RX1, RX2, and RX3 to receive three different forward downlink signals 16, shown as 16-1, 16-2, and 16-3. Each forward downlink signal 16-1, 16-2, and 16-3 is at a different downlink signal frequency and/or polarization, and each forward downlink signal 16 conveys a respective one of the forward user data sub-streams 48-1, 48-2, and 48-3. Each forward downlink signal 16 is transmit beamformed to yield a respective forward user beam 12.

In one or more other embodiments, some, or all receiver circuits within the receiver chain of a UT 18 may be shared. For example, for reception by the UT 18 of two diversity carriers at different frequencies, e.g., 18 GHz and 19 GHz, the UT 18 may use the same LNA, RF converter, analog-to-digital converter (ADC), etc., with the “combined” signal then demodulated separately in the digital domain, for the two carriers. Further, at least some of the DSP or ASIC resources used for demodulation and other signal processing for different received diversity carriers may be shared, e.g., buffers, demodulators, etc. Because such processing ultimately yields information separately extracted from each received diversity carrier, the UT 18 may still be considered as having functionally separate receiver chains for the respective diversity carriers, despite the sharing of some or all the physical circuitry used for reception of two or more diversity carriers—i.e., different forward downlink signals 16.

Although not shown in FIG. 10, it should be understood that transmission by the involved satellite 34 of the forward downlink signal 16-1 forms a forward user beam 12-1 having a forward user beam coverage area 14-1 that encompasses the location of the UT 18, transmission of the forward downlink signal 16-2 forms a forward user beam 12-2 having a forward user beam coverage area 14-2 that encompasses the location of the UT 18, and transmission of the forward downlink signal 16-3 forms a forward user beam 12-3 having a forward user beam coverage area 14-31 that encompasses the location of the UT 18. In other words, the UT 18 is in the overlapped coverage area formed by the three forward user beams 12-1, 12-2, 12-3, with the three forward user beams 12-1, 12-2, and 12-3 acting as a forward spatial diversity beam subset 22 for the UT 18.

One or more of the forward user data sub-streams 48 carries header information that indicates the reassembly order of the forward user data sub-streams 48, for recovery of the corresponding stream of encoded blocks. The UT 18 performs encoded block reassembly using the header information and therefore can be understood as recovering the forward user data stream 46. The UT 18 performs block decoding to recover the original incoming user data stream 26, which it provides to higher-layer processing, e.g., application-layer processing at the UT 18. Configured processing circuitry performs all functionality illustrated in FIG. 10, e.g., the baseband processor 246 and/or the system processor 248.

Note that the UT 18 may additionally or alternatively be served using non-diversity forward transmission, meaning that it is served in the forward direction using a single forward user beam 12 resulting from the beamformed transmission of a single forward downlink signal 16 carrying a single forward user data stream 46 targeted for the UT 18. In such cases, receive processing at the UT 18 relies on a single receiver circuit.

FIG. 11 illustrates an example configuration of a UT 18 in a return transmission context. Higher-level processing in the UT 18 generates an outgoing user data stream 258 for return transmission back to the CCS 42. The UT 18 block encodes the outgoing user data stream 258, e.g., according to a defined transport block size, to obtain a corresponding return user data stream 260. In at least one embodiment, the processing circuitry of the UT 18 is configured to decide whether to use return spatial diversity processing for the return user data stream 260. If return spatial diversity is not employed, the UT 18 transmits the return user data stream 260 via a corresponding return uplink signal 264, which is a radio transmission at a defined return uplink frequency.

If the UT 18 employs return spatial diversity, the return user data stream 260 is divided on a per-block basis, to form two or more return user data sub-streams 262, with FIG. 11 illustrating an example scenario of three return user data sub-streams 262-1, 262-2, and 262-3. Separate transmit signal chains TX1, TX2, and TX3 are used to transmit the respective return user data sub-streams 262-1, 262-2, and 262-3 in respective return uplink signals 264-1, 264-2, and 264-3. At least in the case of simultaneous transmission of the multiple return user data sub-streams 262, the multiple return uplink signals 264 are distinguished from each other in terms of signal frequency and/or polarization.

The illustrated “TX” blocks shall be understood as transmission circuitry including modulation, up conversion, and amplification. As with the earlier discussion of the possibility of shared circuitry for reception of different diversity carriers, at least some transmit circuitry—including in the digital and/or analog domains—may be shared for the transmission of diverse return carriers. Here, “return carrier” refers to a return uplink signal 264 transmitted by the UT 18 using a particular carrier signal frequency and/or polarization.

In some embodiments, the UT 18 decides whether to use return spatial diversity transmission for the return user data stream 260 based on, for example, control signaling sent to it from the SCS 10. When employing return spatial diversity, the UT 18 embeds header information in one or more of the return user data sub-streams 262 formed from a return user data stream 260, for reassembly of the return user data stream 260 at the CCS 42.

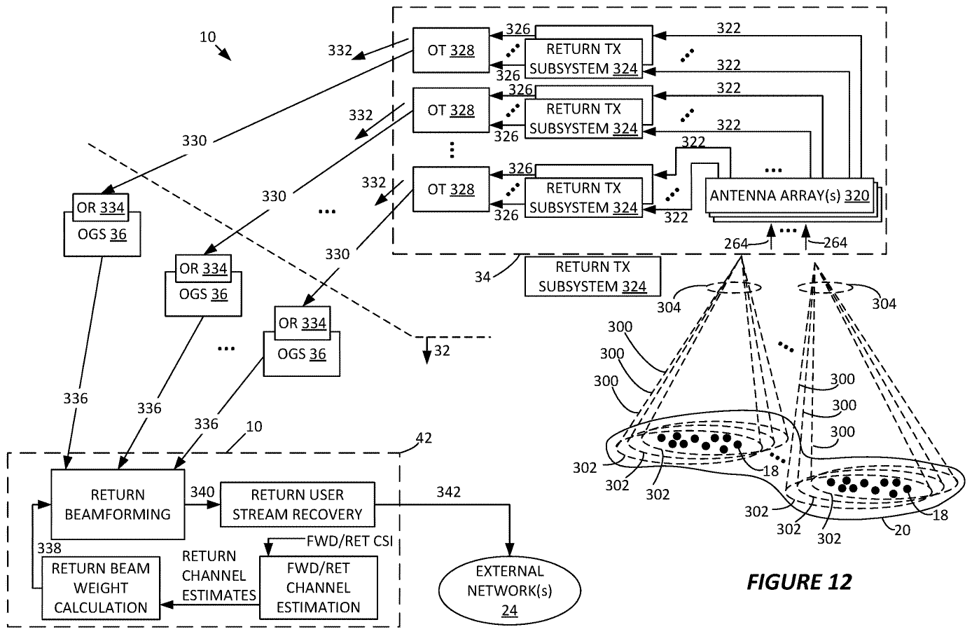

FIG. 12 depicts the SCS 10 in a return direction context. The aggregate coverage area 20 may be divided using a plurality of return user beams 300 having corresponding return user beam coverage areas 302. That is, an overall satellite service area may be logically subdivided into a plurality of return user beam coverage areas, with each return user beam coverage area 302 representing a corresponding return user beam 300. There may be one or more return spatial diversity subsets 304, each comprising two or more return user beams 300 having respective return user beam coverage areas 302 that overlap by more than a threshold amount, such that UTs 18 in the overlapped area may be served in the return direction via two or more of the associated return user beams 300. With respect to such service, the SCS 10 may be understood as providing return spatial transmit diversity.

It is not necessary for each UT 18 covered by a return spatial diversity subset 304 to operate in a return spatial diversity transmission mode. Indeed, individual UTs 18 or groups thereof may be controlled to operate in the return spatial diversity transmission mode, whereas other UTs 18 in the same return user beam coverage overlap may be individually or group-wise controlled to operate in a return non-spatial diversity transmission mode. A UT 18 operating in the return spatial diversity transmission mode subdivides the data comprising a return user data stream into a set of two or more return user data sub-streams, with each return user data sub-stream transmitted as a distinctive radio transmission, using an uplink signal frequency and/or polarization associated with a respective return user beam 300 in the return spatial diversity subset 304 associated with the location of the UT 18. A UT 18 operating in the return non-spatial diversity transmission mode does not subdivide any of the one or more return user data streams it transmits.

In one or more embodiments the return user beams 300 are realized post facto, based on return beamforming in the CCS 42, rather than based on any transmission beamforming performed by the UTs 18 or any reception beamforming applied in the satellite 34. Thus, while FIG. 12 illustrates return user beams 300 in free space, such beams may exist only in a signal processing sense, based on signal weightings applied to recovered signals in the CCS 42. In particular, the CCS 42 in one or more embodiments computes a set of return beam weights representing each return user beam coverage area 302, with that set of return beam weights calculated to maximize the signal-to-noise ratio (SNR) for return uplink signals 264 originating from UTs 18 operating within that return user beam coverage area 302. In this manner, the CCS 42 creates respective return user beam signals, with each return user beam signal corresponding to a particular one of the return user beams 300 and conveying the return uplink signals 264 transmitted by UTs 18 located within the return user beam coverage area 302 corresponding to that particular return user beam 300.

The return beam coverage areas 302 may or may not be the same as the forward beam coverage areas 14. In at least one embodiment, however, the return beam coverage areas 302 and the forward beam coverage areas 14 are the same, at least nominally.

One or more antenna arrays 320 on the satellite 34 receive incoming return uplink signals 264 from respective ones of the UTs 18. The one or more antenna arrays 320 may be the same as or distinct from the one or more antenna arrays 210 shown in FIG. 1.

The individual antenna elements of each antenna array 320 receive superpositions of the return uplink signals 264 from multiple UTs 18, potentially from across multiple return beam coverage areas 302. The respective return uplink signals 264 from different UTs 18 are transmitted according to return link traffic scheduling by the CCS 42. UTs 18 operating with spatial diversity return transmission each transmit multiple return uplink signals 264. Each one of the multiple return uplink signals 264 corresponds to a different return user beam 300, with the different beams distinguished in terms of uplink signal frequency and/or polarization, and with each such return user beam 300 conveying one return user data sub-stream 262 divided from the corresponding return user data stream 260. UTs 18 operating with non-diversity return transmission transmit a return uplink signal 264 conveying an undivided return user data stream 260.

The one or more antenna arrays 320 onboard the satellite 34 output respective sets of return antenna element signals 322, with each such set corresponding to a different combination of return uplink signal frequency and polarization. Each signal line in FIG. 12 that is labeled “322” shall be understood as representing a respective set of return antenna element signals 322. Each return antenna element signal 322 within each set of return antenna element signals 322 may be understood as a composite of return uplink signals 264 received on a corresponding antenna element, for an associated combination of return uplink signal frequency and polarization.

Each return TX subsystem 324 among two or more return TX subsystems 324 onboard the satellite 34 receives a respective set of return antenna element signals 322 and outputs a corresponding set of combined return beam element signals 326. Each signal line in FIG. 12 that is labeled “326” shall be understood as representing a set of combined return beam element signals 326. Each set of combined return beam element signals 326 contains the corresponding return uplink signals 264 received via the antenna array(s) 320 for a corresponding combination of uplink signal frequency and polarization and represents one or more return user beams 300 that use that combination of frequency and polarization. In at least one embodiment, each set of combined return beam element signals 326 is a set of radio signals that are amplified, filtered, and frequency shifted as compared to the corresponding set of return antenna element signals 322.

For implementation of return spatial diversity, the satellite 34 has two or more optical transmitters 328. The return signal paths and processing within the satellite 34 are arranged such that the return uplink signals 264 associated with each respective return user beam 300 included in a given return diversity beam subset are relayed to the ground segment 32 of the SCS 10 using a separate optical transmitter 328, each aimed at a different one of the ground stations 36. That is, at least one subset of the return user beams 300 is arranged as a return spatial diversity beam subset comprising two or more return user beams 300 having distinctive combinations of signal frequency and polarization and having respective return user beam coverage areas 302 that overlap by more than a threshold amount.

Each optical transmitter 328 is coupled to a different ground station 36 via a respective optical return feeder link 330. Consequently, for a UT 18 that, for example, divides a return user data stream 260 into three return user data sub-streams 262 and transmits each such return user data sub-stream 262 in a different return uplink signal 264, each such return uplink signal 264 will be carried back to the CCS 42 over a different optical return feeder link 330. The arrangement provides spatial diversity in the return direction for the different return user data sub-streams 262 and allows the CCS 42 to recover the return user data stream 260 even during temporary fades or disruptions of the individual optical return feeder links 330 being used in the return spatial diversity transmission.

Each optical transmitter 328 onboard the satellite 34, therefore, targets a different ground station 36 and transmits an optical return downlink signal 332 that contains a multiplexed plurality of return optical channel signals, with each such return optical channel signal modulated according to a respective one among the set of combined return beam element signals 326 being transmitted. Each optical transmitter 328 may be arranged like the optical transmitters 38 described for the ground stations 36—see FIG. 7—although weight-savings features may be employed for satellite use. The multiplexing used for the optical return downlink signals 332 may be structured like that shown and detailed for the forward uplink signals 40. For example, any given optical transmitter 328 is used to transmit one or more sets of recovered RF signals 202 based on forming respective sets of return optical channel signals, each occupying a respective segment of optical spectrum. Each optical channel signal in each such set of return optical channel signals is modulated with a respective one among a corresponding set of RF signals 202, and the respective sets of return optical channel signals are aggregated via DWDM to form the corresponding optical return downlink signal 332.

Each ground station 36 includes one or more optical receivers 334, with each one receiving at any given time the return downlink signal 332 from a respective optical transmitter 328 onboard a respective satellite 34. Each such optical receiver 334 may be arranged like the optical receivers 200 onboard the satellite 200—see FIG. 8. As such, each optical receiver 334 demultiplexes the return optical channel signals from the received return downlink signal 332, where each return optical channel signal is at a different optical wavelength and demultiplexing is based on wavelength-based filtering to recover the individual return optical channel signals.

A respective photodetector, such as a photodiode, is used in the ground station 36 to demodulate each return optical channel signal, for recovery of the corresponding combined return beam element signal 326 conveyed by it. That is, the photodetector outputs an analog domain radio signal serving as a recovered version of the corresponding combined return beam element signal 326. In other words, each optical receiver 334 includes an optical demultiplexer to recover each set of return optical channel signals multiplexed in the received return downlink signal 332 and includes a plurality of photodetectors to demodulate each recovered set of return optical channel signals to recover the corresponding sets of combined return beam element signals 326 that are conveyed by the return downlink signal 332. Such operations happen within each ground station 36 for each optical receiver 334 included therein, or at least with respect to each included optical receiver 334 in active operation and receiving a corresponding return downlink signal 334.

Each ground station 36 sends to the CCS 42 a return signal 336 that conveys the recovered set(s) of combined return beam element signals obtained by the ground station 36. Because each recovered set of combined return beam element signals corresponds to one or more return user beams 300 having a particular return uplink signal frequency and polarization, the CCS 42 performs return beamforming on each such set. Particularly, for each recovered set of combined return beam element signals, the CCS 42 individually applies respective sets of return beam weights 338. Individually applying means applying each set of return beam weights 338 independently to a separate copy of the recovered set of combined return beam element signals. Each such weight set is calculated to yield directional sensitivity—enhanced SNR—for return uplink signals 264 originating from UTs 18 in the return user beam coverage area 302 corresponding to the return user beam 300 for which the weight set is calculated.

The CCS 42 applies such processing to every recovered set of combined return beam element signals incoming to the CCS 42 from the ground stations 36, resulting in the generation (on an ongoing basis) of respective return beam signals 340. Each return beam signal 340 corresponds to one of the return user beams 300 and the CCS 42 recovers the return user data streams 260 conveyed in each return beam signal 340, e.g., for forwarding as outgoing user traffic 342 towards their targeted destination addresses via the one or more external networks 24.

For each UT 18 using diversity return transmission, recovery of the corresponding return user data stream 260 is based on the CCS 42 reassembling the multiple return user data sub-streams 262, e.g., using reassembly information carried in one or more of the multiple return user data sub-streams 262. Reassembly yields the block-encoded version of the return user data stream 260, and the CCS 42 performs block decoding to obtain the return user data stream 260.

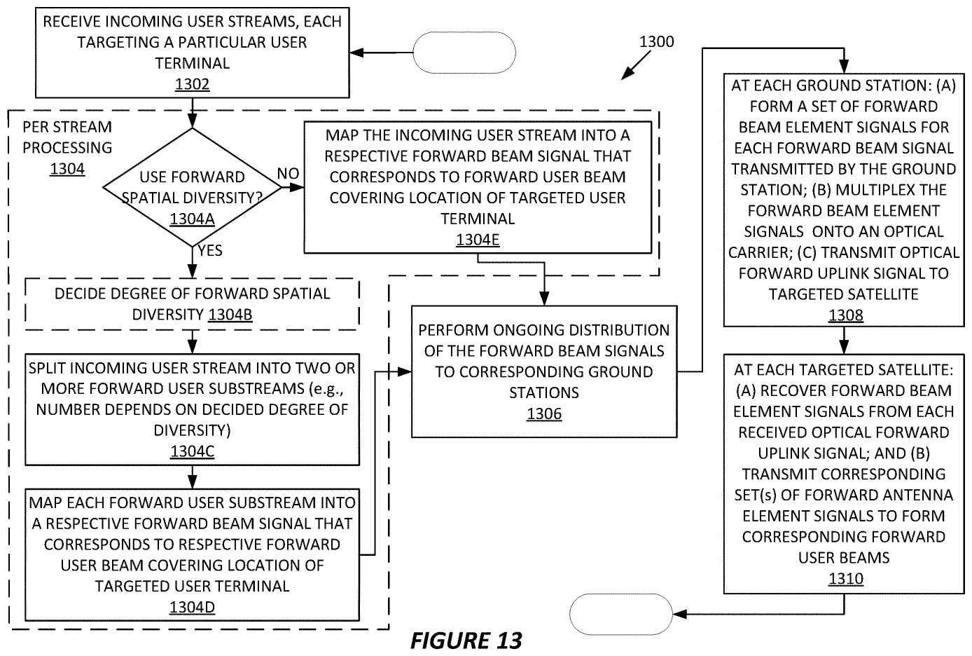

FIG. 13 illustrates an overall method 1300 of operation by the SCS 10 according to an example embodiment. The method 1300 is performed on a looped or ongoing basis, i.e., one or more of the illustrated operations reflect ongoing actions taken with respect to incoming data streams to the SCS 10 for transmission.

The method 1300 includes the SCS 10 receiving (Block 1302) incoming user data streams 26, each targeting a particular UT 18. The method 1300 further includes per-stream processing (Block 1304) that includes for each incoming user data stream 26 determining (Block 1304A) whether to use forward spatial diversity. If so (YES from Block 1304A), the method 1300 optionally includes determining (Block 1304B) the degree of forward spatial diversity, and further includes splitting (Block 1304C) the incoming user data stream into two or more forward user data sub-streams 48, mapping (Block 1304D) each forward user data sub-stream 48 into a respective forward beam signal 44 corresponding to a respective forward user beam 12 covering the location of the targeted UT 18.

If “NO” from Block 1304A, forward spatial diversity transmission is not used for the incoming user data stream 26 and processing continues with mapping the forward user data stream 48 corresponding to the incoming user data stream 26 into a respective forward beam signal 44 that corresponds to a forward user beam 12 covering the location of the targeted UT 18. Such processing includes block encoding the incoming user data stream 26, for example, and the particular forward user beam 12 may be selected as part of load balancing or user scheduling operations.

Further operations in the method 1300 including performing (Block 1306) ongoing distribution of the forward beam signals 44 to corresponding ground stations 36. Block 1308 refers to per ground station operations, which include in each ground station 36: (A) forming a set of forward beam element signals 134 for each forward beam signal 44 transmitted by the ground station 36; (B) multiplexing the forward beam element signals 134 onto an optical carrier; and (C) transmitting the resulting optical forward uplink signal 40 to a targeted satellite 34. Referring back to FIG. 4 momentarily, a ground station 36 forms a respective forward uplink signal 40 that conveys one or more sets of forward beam signals 44.

Such operations include, for each set of forward beam signals 44 to be conveyed in the forward uplink signal 40, forming a set of forward beam element signals 134 for each forward beam signal in the set, and combining those sets of forward beam element signals 134 to form a set of combined forward beam element signals 124. Each set of combined forward beam element signals 124 is used to modulate a respective set of optical carriers 142, to form a corresponding set of forward optical channel signals 146, which are multiplexed to form the optical forward uplink signal 40.

Block 1310 refers to per satellite operations. Such operations include: (A) recovering the one or more sets of combined forward beam element signals 124 from each received forward uplink signal 40; and (B) transmitting the corresponding sets of forward antenna element signals 206 to form corresponding forward user beams 12.

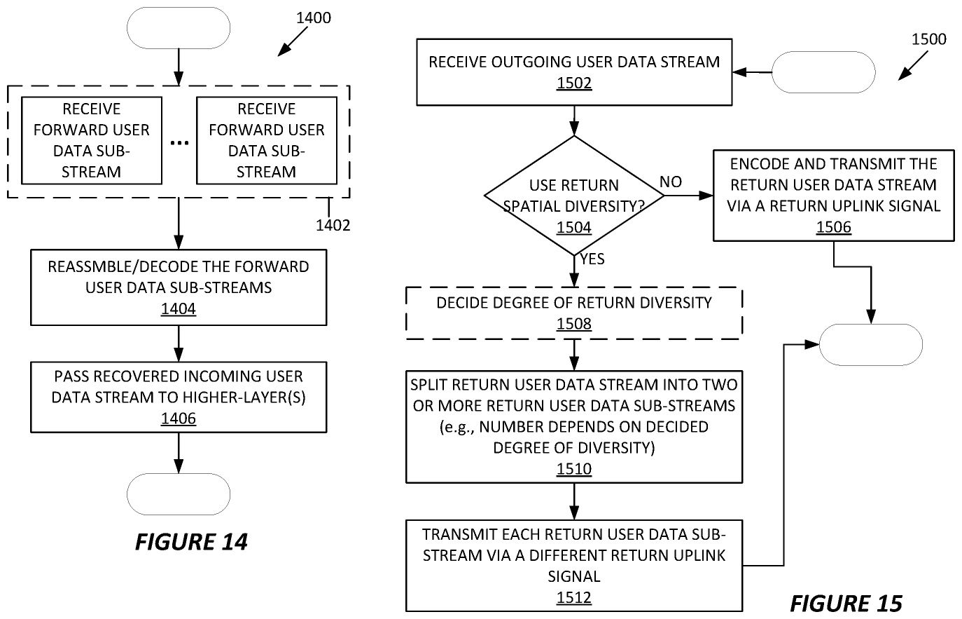

FIG. 14 illustrates a method 1400 of operation performed by a UT 18 according to one embodiment. The illustration assumes forward spatial diversity reception at the UT 18, where the SCS 10 generates a forward user data stream 46 based on block encoding an incoming user data stream 26 for transmission, and dividing each encoded block into distinctive subsets of encoded data to form two or more forward user data sub-streams 48 that are transmitted by the SCS 10 in the forward direction using respective forward user beams 12 corresponding to forward beam signals 44 transmitted via respective forward uplink signals 40 on geographically separated forward optical feeder uplinks 30.

Thus, the method 1400 includes the UT 18 receiving (Block 1402) two or more forward user data sub-streams 48 on different forward user beams 12. The UT 18 reassembles (Block 1404) the forward user data stream from the received forward user data sub-streams 48, including recovering missing information associated with temporary interruptions to individual ones of the froward user data sub-streams 48, based on the Forward Error Correction (FEC) coding applied in generation of the forward user data stream 46. Further, the method 1400 includes passing the recovered incoming user data stream 26 to higher-layer processing at the UT 18.

FIG. 15 illustrates a method 1500 performed by a UT 18 in one embodiment, with respect to return spatial diversity. Processing begins with receiving (Block 1502) an outgoing user data stream 258. For example, an application executing on the UT 18 generates outgoing packet data targeting a remote device or system. Thus, “receiving” here refers to an internal operation within the UT 18, in which the UT 18 decides whether to employ return spatial diversity for the outgoing user data stream 258. If not (NO from Block 1504), processing continues with the UT 18 obtaining (Block 1506) a return user data stream 260 by encoding the outgoing user data stream and transmitting the return user data stream 260 via a return uplink signal 264 that is associated with a single return user beam 300 and is carried by to the CCS 42 via a single optical return feeder link 330.

If return spatial diversity is employed by the UT 18 (YES from Block 1504), processing continues with, in at least one embodiment, deciding (Block 1508) the degree of diversity, which means deciding how many return user data sub-streams 262 into which the return user data stream 260 is split. In other embodiments or in other operating scenarios, the number of return user data sub-streams 262 is a default or predefined number. In at least some embodiments, the SCS 10 is configured to decide the degree of return spatial diversity employed by individual UTs 18, groups of UTs 18, or overall populations of UTs 18. Such decisions are made, for example, based on loading, such as the number of UTs 18 supported, e.g., on a per return user beam basis, the amount(s) or types of traffic originating from individual UTs 18 or groups of UTs 18, e.g., in respective return user beam coverage areas 302. Control signaling sent to UTs 18 by the SCS 10 configures whether or to what extent given UTs 18 use return spatial diversity.

Processing continues with the UT 18 splitting (Block 1510) the return user data stream 260 into two or more return user data sub-streams 262. Splitting refers to dividing each encoded block comprised in the return user data stream 260 into distinctive subsets of encoded data, with the resulting flows of data subsets being the corresponding return user data sub-streams 262. The UT 18 transmits (Block 1512) each return user data sub-stream 262 via different return uplink signal 264. Each return uplink signal 264 corresponds to a different return user beam 300 and is conveyed back to the CCS 42 via different optical return feeder link 330.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-68. (canceled)

69. A method of operation by a ground segment of a satellite communication system comprising the ground segment and a space segment, the method comprising:
receiving incoming user data streams at one or more processing nodes of the ground segment, each incoming user data stream targeting a respective user terminal served by the satellite communication system; and
employing forward spatial diversity transmission for one or more of the incoming user data streams by, for each such incoming user data stream:
forming a corresponding set of two or more forward user data sub-streams by block encoding the incoming user data stream and dividing each encoded data block into different subsets of encoded data; and
mapping each forward user data sub-stream to a respective one among two or more forward beam signals respectively corresponding to two or more forward user beams of the satellite communication system that have respective forward user beam coverage areas encompassing a location of the user terminal targeted by the incoming user data stream; and
sending each forward beam signal to a different ground station among a plurality of geographically distributed ground stations that each transmit to the space segment using a respective optical forward uplink signal.

70. The method according to claim 69, further comprising, at each ground station among the plurality of geographically distributed ground stations, forming the respective forward uplink signal by multiplexing a plurality of forward optical channel signals conveying respective copies of the forward beam signal received by the ground station, weighted for beamforming transmission from respective antenna elements of a targeted antenna array in the space segment, for far-field formation of the corresponding forward user beam.

71. The method according to claim 69, further comprising, for each incoming user data stream for which forward spatial diversity is employed, embedding stream reassembly information in at least one of the forward user data sub-streams in the corresponding set of two or more forward user data sub-streams, the reassembly information providing for ordered reassembly of the incoming user data stream at the targeted user terminal.

72. The method according to claim 69, wherein forward spatial diversity transmission is employed on a selective basis, and wherein the method further includes, for any incoming user data stream for which forward spatial diversity transmission is not employed, employing forward non-diversity transmission in which the incoming user data stream is block encoded and mapped to a single forward beam signal corresponding to a respective forward user beam.

73. The method according to claim 69, wherein the satellite communication system provides a plurality of forward user beams via one or more satellites comprised in the space segment, wherein there are one or more forward spatial diversity beam subsets among the plurality of forward user beams, each forward spatial diversity beam subset comprising two or more forward user beams having distinctive combinations of signal frequency and polarization and having respective forward user beam coverage areas that overlap by more than a threshold amount, and wherein employing forward spatial diversity transmission for the one or more of the incoming user data streams comprises, for each such incoming user data stream, mapping the corresponding two or more forward user data sub-streams to respective forward beam signals corresponding to forward user beams that are members of a forward spatial diversity beam subset that provides coverage with respect to the location of the respective user terminal.

74. The method according to claim 73, wherein forward user traffic mapped to each forward user beam included in each forward spatial diversity beam subset is transmitted from the ground segment to the space segment via a different optical forward uplink signal originating from a different one among two or more among the geographically distributed ground stations.

75. The method according to claim 69, further comprising deciding whether to use forward spatial diversity transmission for any one or more of the incoming user data streams based on corresponding user subscription agreements, such that forward spatial diversity transmission is used for a given incoming user data stream in dependence on the corresponding user subscription agreement.

76. The method according to claim 69, further comprising deciding on an ongoing basis as to whether to use forward spatial diversity transmission for any one or more of the incoming user data streams, based on any one or any combination of: the number of ground stations available for transmitting forward beam signals to the space segment; detected impairments of any one or more of the optical forward uplink signals used to transmit the forward beam signals from the ground segment to the space segment; and loading of the respective forward user beams.

77. The method according to claim 69, wherein the satellite communication system provides a plurality of forward user beams via one or more satellites comprised in the space segment, each forward user beam based on a corresponding forward user beam signal and having a respective combination of downlink signal frequency and polarization, and wherein the method comprises:
receiving, at each of one or more ground stations among the plurality of the ground stations, two or more forward beam signals corresponding to two or more forward user beams having the same respective combination of downlink signal frequency and polarization, and at each such ground station:
forming a respective set of forward beam element signals for each of the two or more forward beam signals by generating a set of radio frequency signals, each radio frequency signal corresponding to an antenna element of a targeted satellite antenna array and modulated by the forward beam signal, and weighting each radio frequency signal with a corresponding forward beam weight from a corresponding set of forward beam weights calculated such that simultaneous transmission of the set of forward beam element signals from the targeted satellite antenna forms the corresponding forward user beam in the far field;
combining the respective sets of forward beam element signals to form a set of combined forward beam element signals;
modulating each optical carrier among a plurality of optical carriers at different wavelengths with a respective one among the set of combined forward beam element signals, to obtain a plurality of forward optical channel signals;
multiplexing the plurality of forward optical channel signals in the optical domain to form a corresponding optical forward uplink signal; and
transmitting the corresponding optical forward uplink signal toward a satellite having the targeted satellite antenna array.

78. A satellite communication system comprising a ground segment, the ground segment comprising:
interface circuitry configured to receive incoming user data streams, each incoming user data stream targeting a respective user terminal served by the satellite communication system; and
processing circuitry that is configured to employ forward spatial diversity transmission for one or more of the incoming user data streams based on being configured to, for each such incoming user data stream:
form a corresponding set of two or more forward user data sub-streams by block encoding the incoming user data stream and dividing each encoded data block into different subsets of encoded data; and
map each forward user data sub-stream to a respective one among two or more forward beam signals respectively corresponding to two or more forward user beams of the satellite communication system that have respective forward user beam coverage areas encompassing a location of the user terminal targeted by the incoming user data stream; and
send each forward beam signal to a different ground station among a plurality of geographically distributed ground stations, with each ground station configured to transmit to a space segment of the satellite communications system using a respective optical forward uplink signal.

79. The satellite communications system according to claim 78, further comprising the plurality of geographically distributed ground stations, wherein each ground station among the plurality of geographically distributed ground stations is configured to form the respective forward uplink signal by multiplexing a plurality of forward optical channel signals conveying respective copies of the forward beam signal received by the ground station, weighted for beamforming transmission from respective antenna elements of a targeted antenna array in the space segment, for far-field formation of the corresponding forward user beam.

80. The satellite communications system according to claim 78, wherein, for each incoming user data stream for which forward spatial diversity is employed, processing circuitry in the ground segment is configured to embed stream reassembly information in at least one of the forward user data sub-streams in the corresponding set of two or more forward user data sub-streams, the reassembly information providing for ordered reassembly of the incoming user data stream at the targeted user terminal.

81. The satellite communications system according to claim 78, wherein forward spatial diversity transmission is employed on a selective basis, and wherein processing circuitry included in the ground segment is configured to, for any incoming user data stream for which forward spatial diversity transmission is not employed, employ forward non-diversity transmission in which the incoming user data stream is block encoded and mapped to a single forward beam signal corresponding to a respective forward user beam.

82. The satellite communications system according to claim 78, wherein the satellite communication system provides a plurality of forward user beams via one or more satellites comprised in the space segment, wherein there are one or more forward spatial diversity beam subsets among the plurality of forward user beams, each forward spatial diversity beam subset comprising two or more forward user beams having distinctive combinations of signal frequency and polarization and having respective forward user beam coverage areas that overlap by more than a threshold amount, and wherein, to employ forward spatial diversity transmission for the one or more of the incoming user data streams, processing circuitry in the ground segment is configured to, for each such incoming user data stream, map the corresponding two or more forward user data sub-streams to respective forward beam signals corresponding to forward user beams that are members of a forward spatial diversity beam subset that provides coverage with respect to the location of the respective user terminal.

83. The satellite communications system according to claim 82, wherein the ground segment is configured such that forward user traffic mapped to each forward user beam included in each forward spatial diversity beam subset is transmitted from the ground segment to the space segment via a different optical forward uplink signal originating from a different one among two or more geographically distributed ground stations.

84. The satellite communications system according to claim 78, wherein processing circuitry included in the ground segment is configured to decide whether to use forward spatial diversity transmission for any one or more of the incoming user data streams based on corresponding user subscription agreements, such that forward spatial diversity transmission is used for a given incoming user data stream in dependence on the corresponding user subscription agreement.

85. The satellite communications system according to claim 78, wherein processing circuitry included in the ground segment is configured to decide on an ongoing basis as to whether to use forward spatial diversity transmission for any one or more of the incoming user data streams, based on any one or any combination of: the number of ground stations available for transmitting forward beam signals to the space segment; detected impairments of any one or more of the optical forward uplink signals used to transmit the forward beam signals from the ground segment to the space segment; and loading of the respective forward user beams.

86. The satellite communications system according to claim 78, wherein the satellite communication system provides a plurality of forward user beams via one or more satellites comprised in the space segment, each forward user beam based on a corresponding forward user beam signal and having a respective combination of downlink signal frequency and polarization, and wherein each ground station comprises:
interface circuitry configured to receive two or more forward beam signals corresponding to two or more forward user beams having the same respective combination of downlink signal frequency and polarization; and
processing and transmission circuitry configured to:
form a respective set of forward beam element signals for each of the two or more forward beam signals by generating a set of radio frequency signals, each radio frequency signal corresponding to an antenna element of a targeted satellite antenna array and modulated by the forward beam signal, and weighting each radio frequency signal with a corresponding forward beam weight from a corresponding set of forward beam weights calculated such that simultaneous transmission of the set of forward beam element signals from the targeted satellite antenna array forms the corresponding forward user beam in the far field;
combine the respective sets of forward beam element signals to form a set of combined forward beam element signals;
modulate each optical carrier among a plurality of optical carriers at different wavelengths with a respective one among the set of combined forward beam element signals, to obtain a plurality of forward optical channel signals;
multiplex the plurality of forward optical channel signals in the optical domain to form a corresponding optical forward uplink signal; and
transmit the corresponding optical forward uplink signal toward a satellite having the targeted satellite antenna array.
